(19) United States
(12) Patent Application Publication
(10) Pub. No.: US 2013/0036385 A1
(43) Pub. Date: Feb. 7, 2013

(54) COMPUTER INTERFACE AND SYSTEM FOR THE GRAPHICAL REPRESENTATION OF ORDERED GROUPS OF ELEMENTS AND THE ABILITY TO INTERACT WITH THESE ELEMENTS

(71) Applicants: Pierre-Jean Camillieri, London (GB); Julien Bieren, London (GB)

(72) Inventors: Pierre-Jean Camillieri, London (GB); Julien Bieren, London (GB)

(21) Appl. No.: 13/563,847

(22) Filed: Aug. 1, 2012

Related U.S. Application Data
(60) Provisional application No. 61/514,221, filed on Aug. 2, 2011.

(51) Int. Cl. G06F 3/048

(52) U.S. Cl. 715/821

(57) ABSTRACT

In general, the system and methods herein described are configured to providing novel ordering and display capabilities to computing device. Specifically, certain embodiments of the present system described here are able to graphically represent groups of elements in an ordered way within a display canvas. In certain embodiments, the display canvas may be limited in size (e.g., not all groups should be displayed at once). The system is configured to let a user interact with content in various ways, including: selecting/de-selecting and/or discarding/un-discarding individual elements; filter elements based on specific criteria; and automatically refresh the groups and elements displayed on the page based on user input.

### CROSS REFERENCE TO RELATED APPLICATIONS

This application claims the benefit of U.S. Provisional Patent Application No. 61/514,221 filed Aug. 2, 2011, the entire disclosure of which is incorporated herein by reference.

### FIELD OF THE INVENTION

In general, the system and methods herein described are configured to providing novel ordering and display capabilities to computing device. Specifically, certain embodiments of the present system described here are able to graphically represent groups of elements in an ordered way within a display canvas. In certain embodiments, the display canvas may be limited in size (e.g., not all groups should be displayed at once). The system is configured to let a user interact with content in various ways, including: selecting/de-selecting and/or discarding/un-discarding individual elements; filter elements based on specific criteria; and automatically refresh the groups and elements displayed on the page based on user input.

### BACKGROUND OF THE INVENTION

As is known in the art, an element is an object that can be represented in a user interface as displayed on a computing device. A pool of elements is a group of elements that can be arranged into one or more organized groups of elements appropriate for display. The process used to create unordered groups is not the purpose of this invention and it is not discussed here, as one of ordinary skill in the art would appreciate and comprehend how to create such unordered groups.

With an ever increasing amount of data needing to be displayed to users and, in many cases, ever shrinking display real estate due to the ever increasing use and popularity of mobile computing devices with limited screen size and resolution (e.g., tablet PCs, smartphones), the ability to sort and present information in a meaningful manner on a display is becoming more and more complicated.

Certain systems allow for manual selection or unordered presentation of elements on a display. However, this detracts from the relevance of the elements presented as useful or desirable elements may not be displayed in any cognizant manner.

Therefore, there is a need in the art for a system and method for providing graphical representation of ordered groups of elements in a cognizant and relevant manner as well as the ability to interact with these elements while preserving an ordered presentation. These and other features and advantages of the present invention will be explained and will become obvious to one skilled in the art through the summary of the invention that follows.

### SUMMARY OF THE INVENTION

Accordingly, it is an aspect of the present invention to provide a system and method for graphical representation of ordered groups of elements in a cognizant and relevant manner as well as the ability to interact with these elements while preserving an ordered presentation.

According to an embodiment of the present invention, a computer implemented system for graphical representation of ordered groups includes: a computing device, the computing device including physical memory storing instructions that cause the computing device to: receive input from a user; create updated criteria based at least in part on input from said user; apply updated criteria to a set of elements; mark one or more elements of said set of elements with a state; identify one or more groups of elements that are in a valid state; display at least a portion of said one or more groups in a ranked manner; and differentiate at least a portion of said one or more groups of elements visually.

According to an embodiment of the present invention, the physical memory further stores instructions that cause the computing device to store one or more criteria from the group comprising initial criteria and updated criteria.

According to an embodiment of the present invention, the state is selected from the group comprising selected, discarded, invalid and unavailable.

According to an embodiment of the present invention, one or more groups with elements marked as discarded are removed.

According to an embodiment of the present invention, one or more groups with elements marked as invalid are removed.

According to an embodiment of the present invention, one or more groups with elements marked as unavailable are removed.

According to an embodiment of the present invention, the ranked manner is based at least in part on a score associated with each of said one or more groups.

According to an embodiment of the present invention, the score of each of said one or more groups is optimized based at least in part on said updated criteria.

According to an embodiment of the present invention, the valid state is applied to a group of elements, wherein said group of elements contains elements that satisfy filters set by the user and do not contain discarded elements.

According to an embodiment of the present invention, the group of elements contain one or more selected elements, wherein said one or more selected elements are identified by the user.

According to an embodiment of the present invention, a computer implemented method for graphical representation of ordered groups of elements includes the steps of: receiving input from a user; creating updated criteria based at least in part on input from said user; applying updated criteria to a set of elements; marking one or more elements of said set of elements with a state; identifying one or more groups of elements that are in a valid state; displaying at least a portion of said one or more groups in a ranked manner; and differentiating at least a portion of said one or more groups of elements visually.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### DETAILED DESCRIPTION

According to an embodiment of the present invention, the system and methods herein described are accomplished through the use of one or more computing devices. One of ordinary skill in the art would appreciate that a computing device appropriate for use with embodiments of the present application may generally be comprised of one or more of a Central processing Unit (CPU), Random Access Memory (RAM), a display device (e.g., monitor, touch screen, projector) and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

According to an embodiment of the present invention, the system described here is able to graphically represent groups of elements in an ordered way within a display canvas. In certain embodiments, the display canvas may be limited in size (e.g., not all groups should be displayed at once). As such, the system is configured to let a user interact with content in various ways, including: selecting/de-selecting and/or discarding/un-discarding individual elements; filter elements based on specific criteria; and automatically refresh the groups and elements displayed on the page based on user input. While embodiments of the present invention are discussed as used in conjunction with display areas/canvases of limited in size, other embodiments may be utilized with display areas/canvases of unlimited size or where size is not a limiting factor.

Therefore, on user input the system is configured to: identify the groups that are still valid; display the groups in a ranked manner; and visually differentiate elements that are not used in any valid group anymore versus those that are still used in at least one valid group. “Valid” groups: contain elements that satisfy the filters set by the user, contain selected elements at least once (if the user has selected some elements), and do not contain discarded elements (if the user has discarded some elements).

A group contains one or more elements. Elements within a group can be duplicated and a “score” may be assigned to each group. This score may be calculated by an external system which is not discussed here, as one of ordinary skill in the art would appreciate and comprehend how to calculate such a score.

The “score” measures how optimized the group is based on specific criteria. The groups can be ranked with this score. Groups may be comprised of any combination of n events. As a consequence, the number of groups can be very large. The primary interest for a user is to visualize the groups, ranked by their score. The way in which the user interacts with the groups is by either selecting or discarding specific elements, or by filtering elements based on specific criteria.

“Selecting” an element means that the user only wants to see groups that feature this element at least once.

“Discarding” an element means that the user doesn't want to see any groups featuring this element.

“Filtering” means that the user can set some criteria, and all elements that do not comply with these criteria are excluded.

As a result, each element can be marked in 4 different ways: (1) selected; (2) discarded; (3) invalid (when it doesn't satisfy filters); and/or (4) unavailable (an element is “unavailable” when it is not used by any valid groups). An element is “not-marked” if none of the above applies.

The first two marks are mutually exclusive: an element can get one or the other, but not both at the same time. The latter two marks can be applied in addition to the selected and discarded marks. For example, a selected element can become invalid due to filter changes. The invalid mark will prevail and valid groups won't contain this element. In another example, if an invalid element is selected, it still remains invalid and valid groups will not contain it.

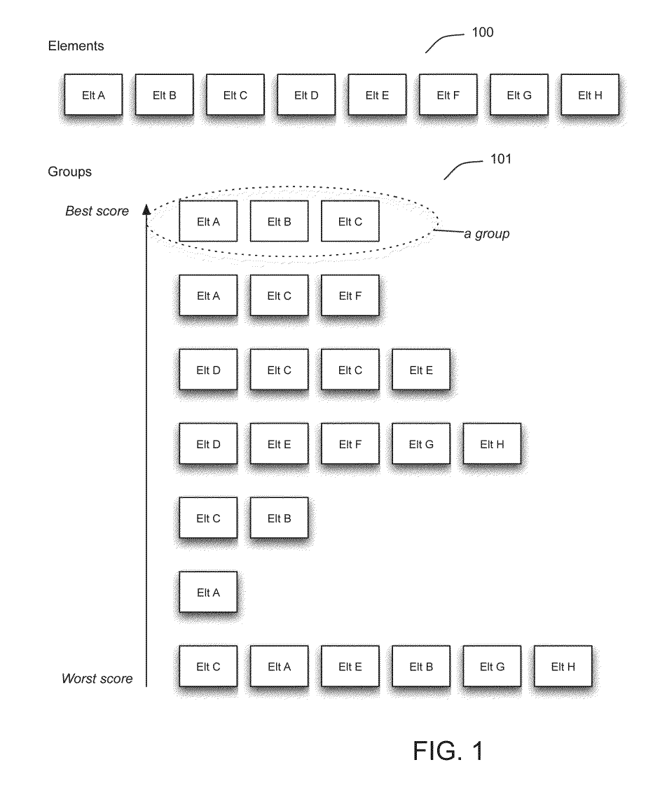

Turning now to FIG. 1, an illustration of an exemplary starting state is shown. Set 100 shows all the elements available in this specific example. Set 101 shows all the valid groups formed using the events from set 100. Note the validity of these groups may be determined by a separate program outside of this invention. These groups all have a “score” with which they can be ranked. The scoring may also be generated by a separate program, outside of the scope of this invention. In an alternate embodiment, in accordance with the present invention, validation and scoring can be performed by components of the invention.

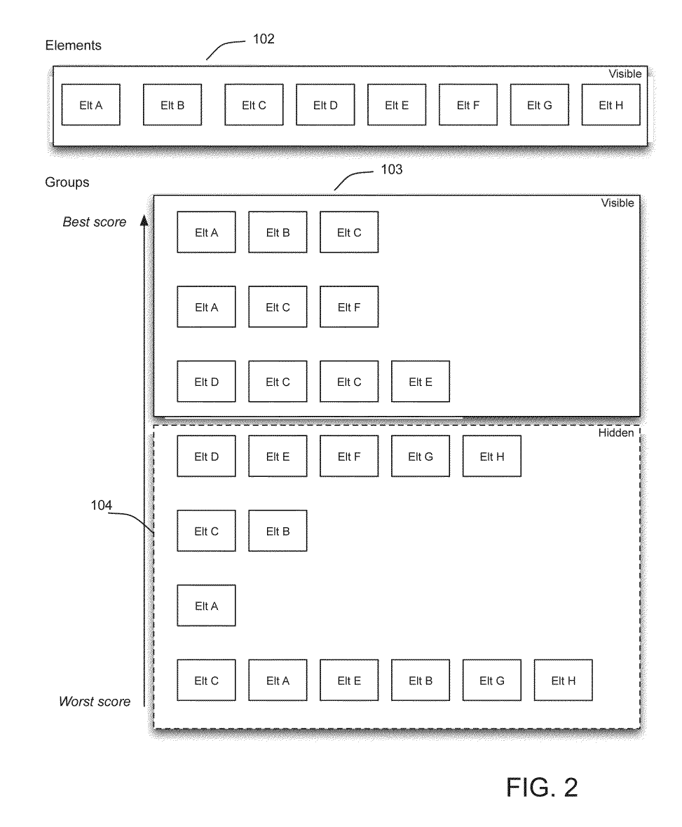

FIG. 2 shows an exemplary embodiment, in accordance with the present invention, what is presented to the user (the user interface). In set 102, the system presents to the user all the elements that can be used in the groups. In set 103, the system is showing the 3 best groups that came out of the separate program, ranked by their score. Note that the number of groups shown can be adjusted by the user, depending on the screen real estate available, set 104 is hidden to the user. It contains the following, lower ranked groups.

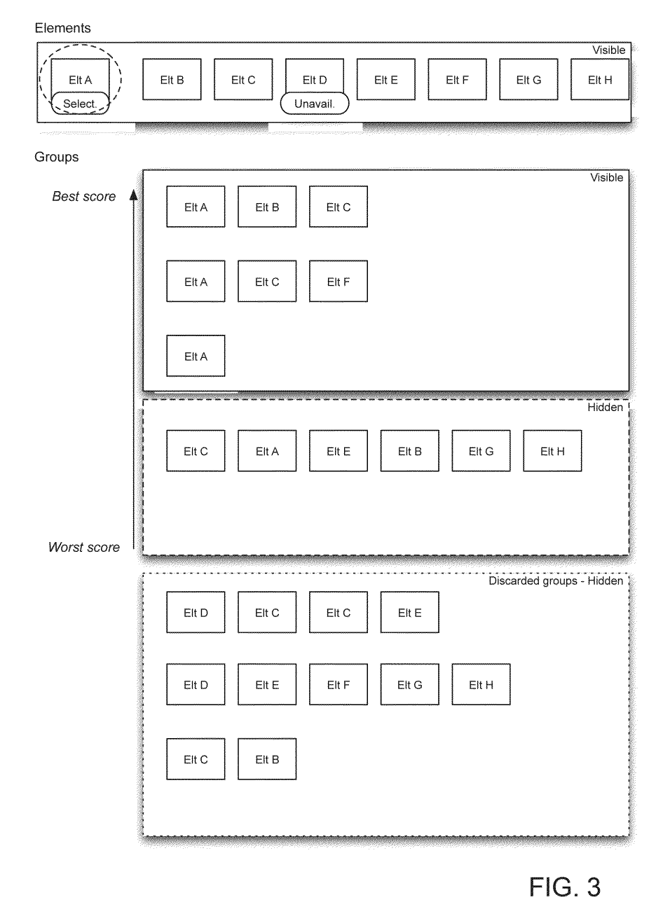

In FIG. 3, the user has selected the element A. This action creates a new criteria: all groups shown must feature the element A at least once. With this new criteria, the system calculates which groups are still valid, and which groups should be discarded.

In the example shown, 3 groups become discarded and are hidden. In addition, the system re-orders the valid groups left, per their respective score. Therefore, the 3 top groups have now changed. The group formed of the singleton Element A which used to be in sixth position is now in third and becomes visible.

The system may also be configured to detect whether some elements are not used in any of the valid groups left. If some elements are in this situation, they are marked as “Unavailable”. This is the case for element D. In this example, element D is shown with an “Unavailable” label on it. Note that this “Unavailable” mark could be displayed differently. For example, element D opacity could be reduced, or it could be marked with a specific color, etc.

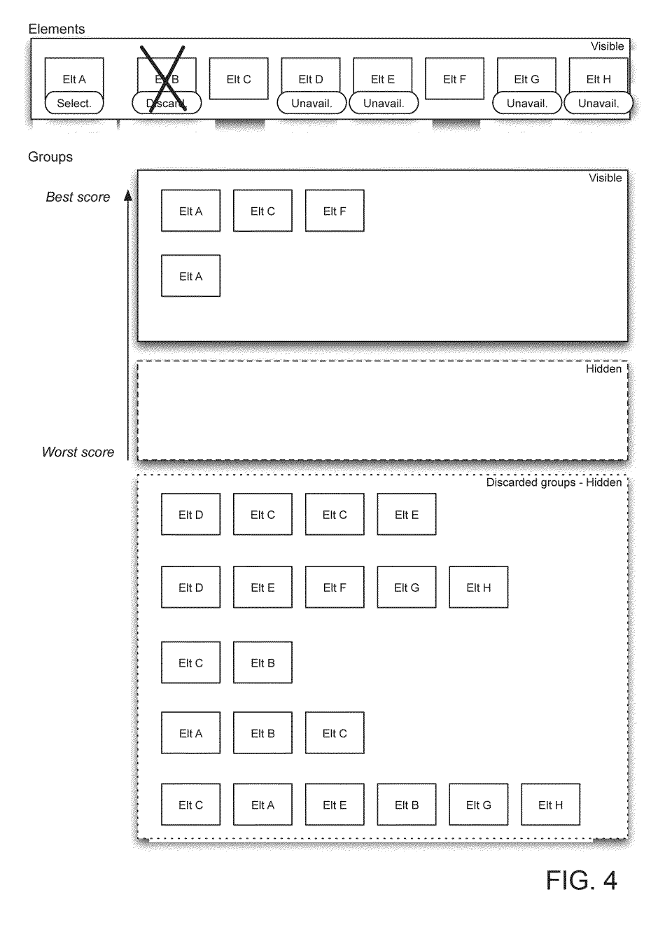

In FIG. 4, the user has now decided to discard the element B. The same process as for FIG. 3 is repeated: this is a new criteria, added to the previous set. The system takes it into account to recalculate which groups are not valid anymore and discards them. It also re-orders the remaining valid group. There are only two of them in this specific example. In addition, with element A selected and element B discarded, there are no more valid groups featuring element E, G and H and these three elements are therefore marked as unavailable.

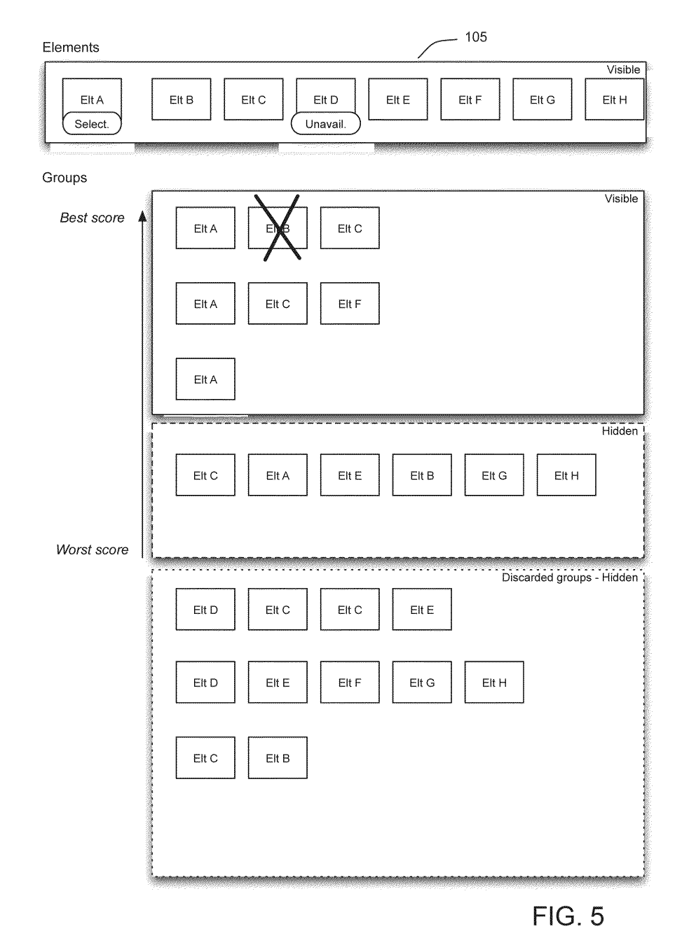

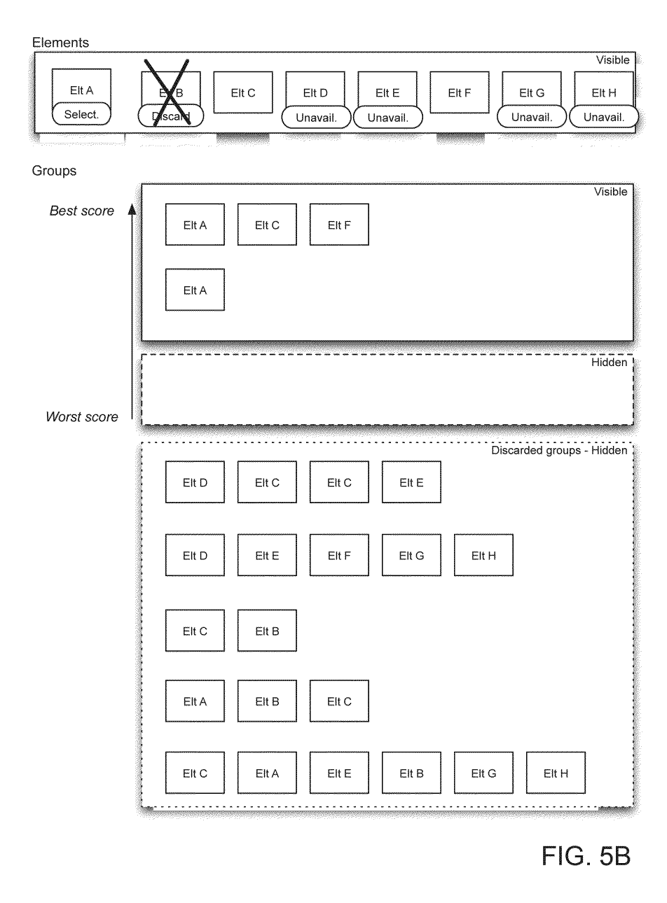

FIGS. 5-5B illustrate the fact that the user can also decide to select or discard an element directly in the visible groups section (i.e., it does not have to be done in the elements section). The effect is the same in both cases.

In fact, in some cases it might be decided to not show the elements section 105 at all by default. Indeed, in the case there are a very large number of individual elements available, it might be preferable to have this section hidden. In this case, the user interaction will happen directly in the groups section. The system can still give to the user the ability to reveal the elements section if she wishes to see them and interact with them directly.

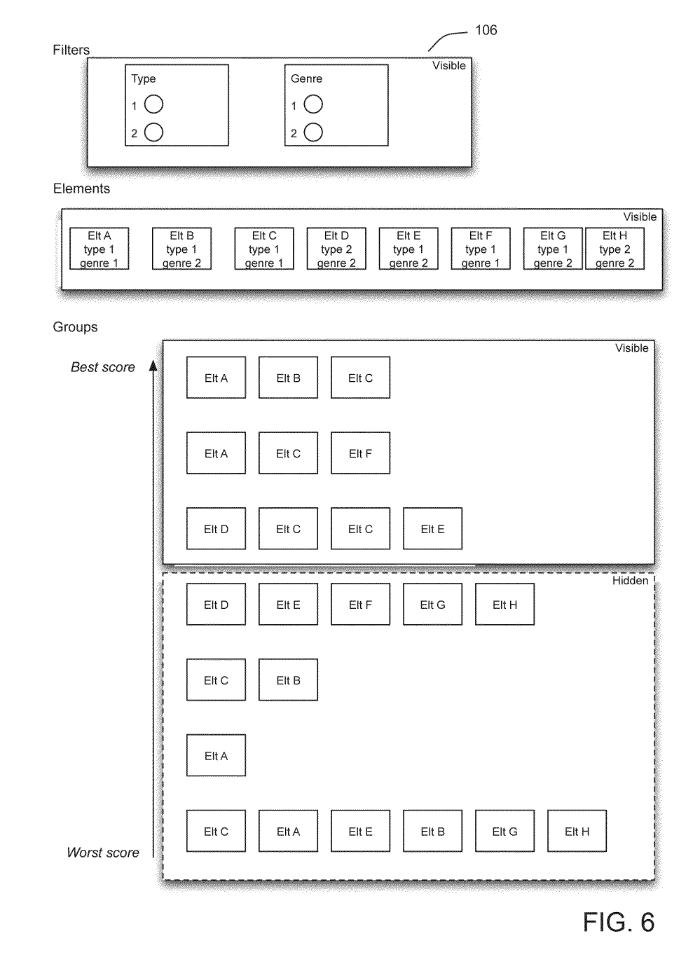

FIG. 6 illustrates the use of filters (106). Indeed, the system gives to the user the possibility to select or discard groups of elements in one action by modifying filters. Filters relate to elements characteristics. In the example shown in FIG. 6, each element has two characteristics: type and genre. The user can apply filters on these characteristics. One of ordinary skill in the art would appreciate that any number of characteristics and filters may be used in accordance with embodiments of the present invention, and embodiments of the present invention are contemplated for use with any number of characteristics and filters.

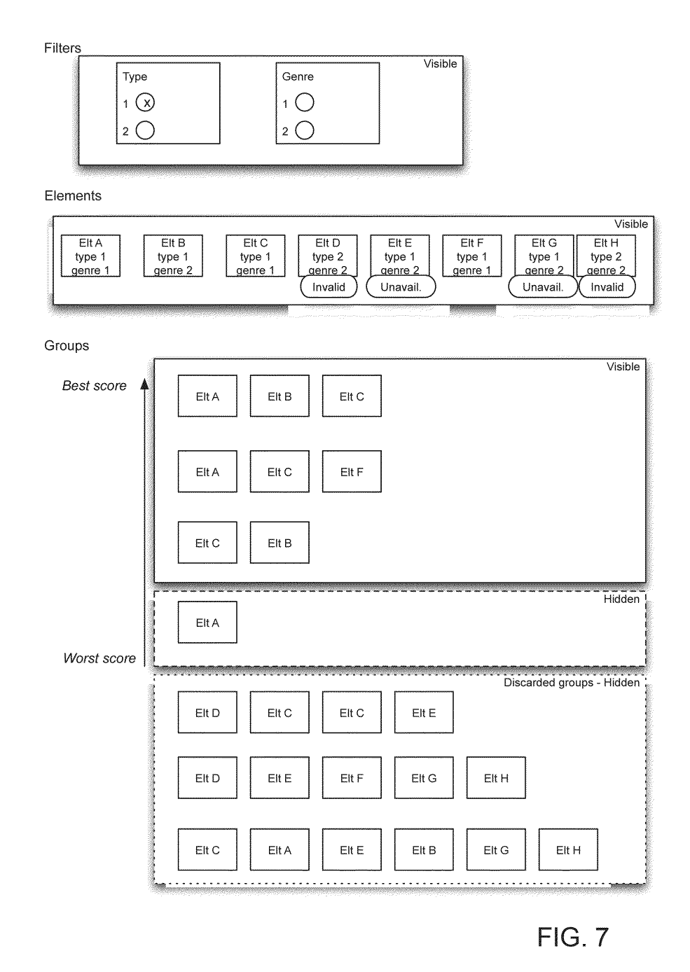

In FIG. 7, the user is filtering events by type. She only wants to see groups featuring elements of type 1. The system marks as invalid all elements whose type is not 1. It calculates which groups are still valid, re-orders them, and shows the top 3 ones. Note that despite the fact element E is of type 1 so still valid, it gets marked as unavailable since it is not part of any of the remaining valid groups.

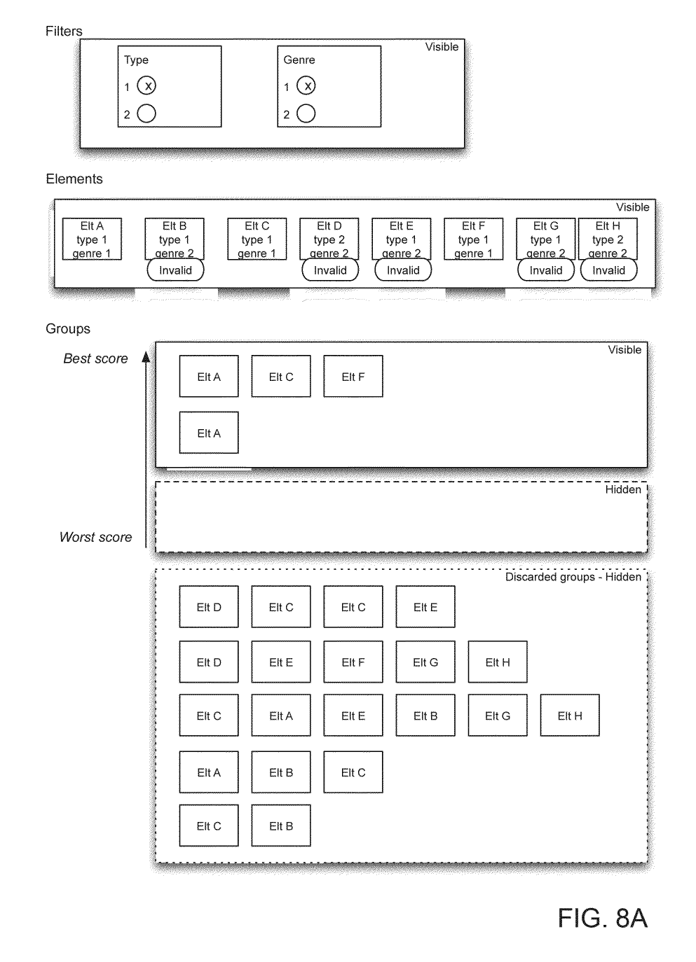

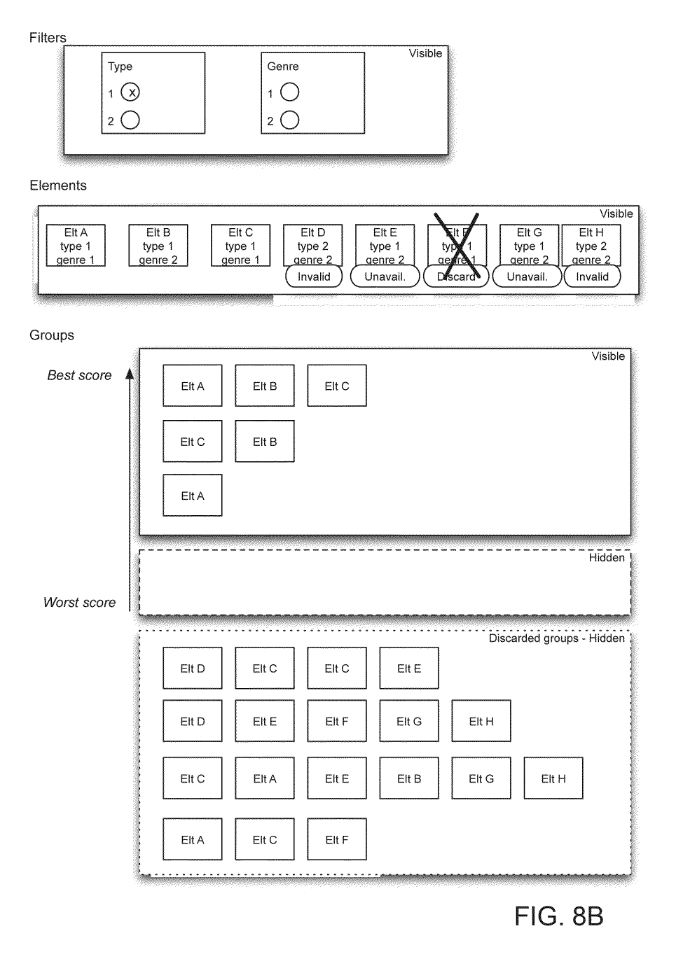

In FIG. 8a, the user decides she only wants to see elements of genre 1. The system marks as invalid all elements that are not of genre 1, calculates which groups are still valid, re-orders them and shows the top 3 ones.

FIG. 8b illustrates the fact that the user is able to combine the use of filters with the selection or discard of specific elements. In this case, the user had filtered elements of type 1 (in FIG. 7), and she then discarded element F specifically.

According to an embodiment of the present invention, the system may be configured in such a manner that every action from the user is reversible. For example, the user can decide to deselect an element that she had selected, or to un-discard an element that she discarded previously. The act of reverting a previous action is treated by the system as any other action. For example, starting from state A, the user discards element X: the state becomes B and the set of criteria includes “X is discarded”. If the user un-discards element X, “X is discarded” is removed from the set of criteria, which are now similar to what they were before and the system automatically goes back to state A. Reverting an action can be done at any time. It does not have to be done right after the original action.

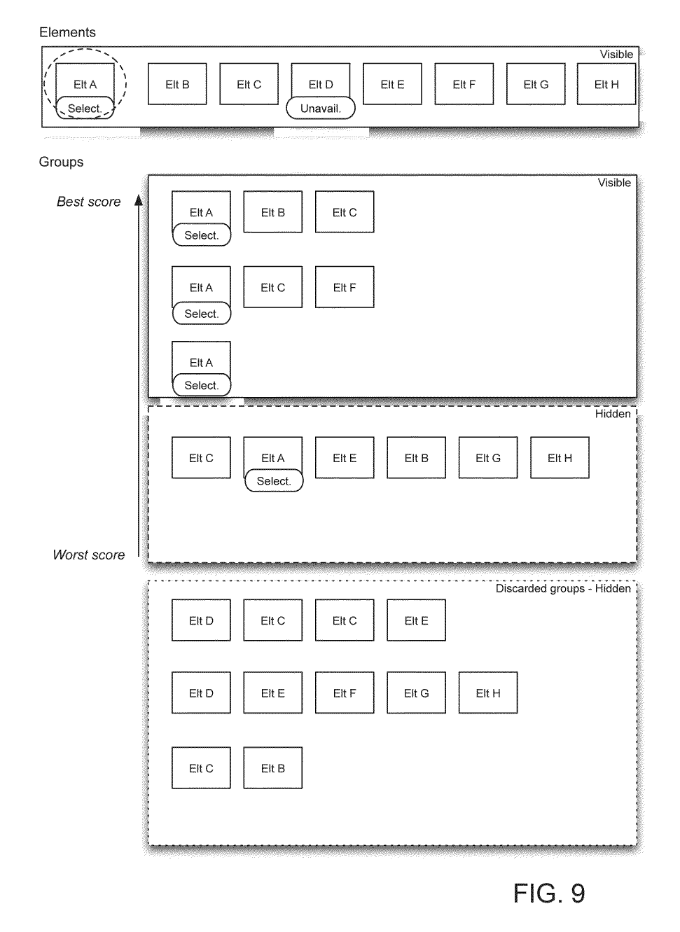

FIG. 9 illustrates the fact that when a mark is applied to an element (the “Selected” mark in this specific example), the graphical representation of the mark (for example: opacity, color, pictogram, etc.) may be applied to all the instances of this element, including all its instances in the groups section.

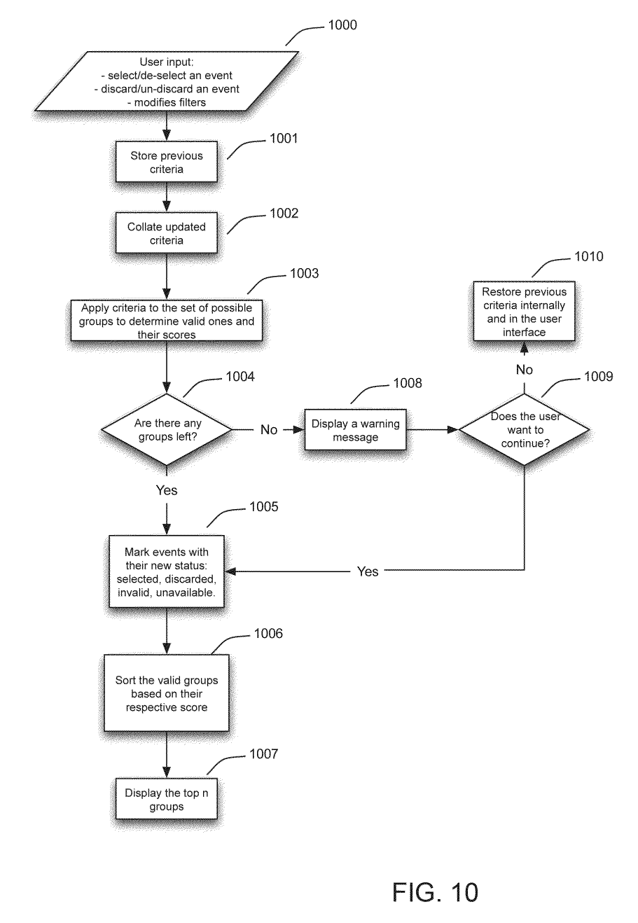

FIG. 10 is a flow diagram illustrating the process of taking a user action into account to update the interface accordingly.

Before entering step 1000, the state is as follow: (1) a number of elements are displayed (or hidden) in the user interface—some of these elements might be selected, some might be discarded, some might be marked as invalid or unavailable; (2) a set of groups has been returned by an external system—these groups are all the groups “valid” for the set of elements considered with the validity of these groups determined by a separate system; (3) n groups are valid and visible, ordered by their respective score (Note n>=0); and (4) m other valid groups, lower ranked, are hidden (m>=0).

At step 1000, the user interface receives a user action. The user can be selecting or deselecting, discarding or un-discarding a specific element, or modifying the filters.

At step 1001, the system reacts by first storing the criteria before the user action. This step is necessary to be able to cancel the user action if she wants to at a later stage in the process.

At step 1002, the user action is converted into a criteria, added to the existing ones.

At step 1003, the system applies the criteria to the set of possible groups. It outputs the valid groups with their respective score

At Step 1004, Case 1: the number of valid groups is superior or equal to 1. The system goes to step 1005. In 1005, the system marks individual elements (if applicable) based on their new state: selected, discarded, invalid, unavailable or not-marked. At step 1006, the system orders the valid groups left based on their score. At step 1007, the system updates the user interface to show the n higher ranked groups. Note if the number X of valid groups left is inferior to n, the system shows the X valid groups.

At step 1004, Case 2: there are no more valid groups.

At step 1008: the system displays a warning message to the user, asking the user whether she wants to continue. If yes, the system goes to step 1005 as above. At 1007, the number of valid groups shown will be null. If no, the system goes to 1010 and restores the previous criteria internally and in the user interface. For example, if the user had discarded a specific element, it becomes un-discarded again.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented system for graphical representation of ordered groups, comprising:
a computing device, the computing device including physical memory storing instructions that cause the computing device to:
receive input from a user;
create updated criteria based at least in part on input from said user;
apply updated criteria to a set of elements;
mark one or more elements of said set of elements with a state;
identify one or more groups of elements that are in a valid state;
display at least a portion of said one or more groups in a ranked manner; and
differentiate at least a portion of said one or more groups of elements visually.

2. The computer implemented system of claim 1, wherein said physical memory further stores instructions that cause the computing device to store one or more criteria from the group comprising initial criteria and updated criteria.

3. The computer implemented system of claim 1, wherein the state is selected from the group comprising, selected, discarded, invalid and unavailable.

4. The computer implemented system of claim 3, wherein one or more groups with elements marked as discarded are removed.

5. The computer implemented system of claim 3, wherein one or more groups with elements marked as invalid are removed.

6. The computer implemented system of claim 3, wherein one or more groups with elements marked as unavailable are removed.

7. The computer implemented system of claim 1, wherein the ranked manner is based at least in part on a score associated with each of said one or more groups.

8. The computer implemented system of claim 1, wherein the score of each of said one or more groups is optimized based at least in part on said updated criteria.

9. The computer implemented system of claim 1, wherein said valid state is applied to a group of elements, wherein said group of elements contains elements that satisfy filters set by the user, contain one or more selected elements and do not contain discarded elements.

10. The computer implemented system of claim 1, wherein the group of elements contain one or more selected elements, wherein said one or more selected elements are identified by the user.

11. A computer implemented method for graphical representation of ordered groups of elements, wherein said method comprises the steps of:
receiving input from a user;
creating updated criteria based at least in part on input from said user;
applying updated criteria to a set of elements;
marking one or more elements of said set of elements with a state;
identifying one or more groups of elements that are in a valid state;
displaying at least a portion of said one or more groups in a ranked manner; and
differentiating at least a portion of said one or more groups of elements visually.

12. The computer implemented method of claim 10, further comprising the step of storing one or more criteria from the group comprising initial criteria and updated criteria.

13. The computer implemented method of claim 10, wherein the state is selected from the group comprising selected, discarded, invalid and unavailable.

14. The computer implemented method of claim 12, wherein one or more groups with elements marked as discarded are removed.

15. The computer implemented method of claim 12, wherein one or more groups with elements marked as invalid are removed.

16. The computer implemented method of claim 12, wherein one or more groups with elements marked as unavailable are removed.

17. The computer implemented method of claim 12, wherein the ranked manner is based at least in part on a score associated with each of said one or more groups.

18. The computer implemented method of claim 12, wherein the score of each of said one or more groups is optimized based at least in part on said updated criteria.

19. The computer implemented method of claim 12, wherein said valid state is applied to a group of elements, wherein said group of elements contains elements that satisfy filters set by the user, contain one or more selected elements and do not contain discarded elements.

20. The computer implemented method of claim 11, wherein the group of elements contain one or more selected elements, wherein said one or more selected elements are identified by the user.
